(19) United States
(12) Patent Application Publication
(10) Pub. No.: US 2026/0249711 A1
(43) Pub. Date: Aug. 27, 2026

(54) METHOD FOR CALCULATING OPERATING SETPOINTS OF A FIRST ENGINE AND A SECOND ENGINE OF THE SAME VEHICLE

(71) Applicant: AMPERE S.A.S., Boulogne Billancourt (FR)

(72) Inventors: Loic LE MAO, Guyancourt Cedex (FR); Pascal LE-NEEL, Guyancourt Cedex (FR)

(73) Assignee: AMPERE S.A.S., Boulogne Billancourt (FR)

(21) Appl. No.: 19/125,100

(22) PCT Filed: Oct. 3, 2023
(86) PCT No.: PCT/EP2023/077335

§ 371 Date: May 15, 2026

(30) Foreign Application Priority Data
Oct. 31, 2022 (FR) FR2211347

(51) Int. Cl. B60L 15/20

(52) U.S. Cl. CPC B60L 15/2045; B60L 2220/14; B60L 2220/42; B60L 2220/50; B60L 2240/421; B60L 2240/423; B60L 2240/425; B60L 2240/429; B60L 2240/662

(57) ABSTRACT

A method for calculating operating setpoints of a first engine and a second engine of the same vehicle. The method includes calculating a thickness of a patina formed on the surface of a ring of the second engine, and, if the thickness of the patina is strictly less than a threshold, calculating the operating setpoints of the first engine and the second engine according to a strategy intended for causing an electric current to flow in the supply device in order to promote the regeneration of the patina.

### TECHNICAL FIELD OF INVENTION

The invention relates to a method for computing the drive torque settings of a first motor and second motor of the same vehicle, the second motor being an electric motor comprising an energizing device comprising a ring and a brush rubbing on the ring.

### PRIOR ART

Certain vehicles, in particular certain motor vehicles, comprise two drive motors: a main motor and an auxiliary motor. The main motor has enough power to drive the vehicle when low or medium torque is required. The main motor is, for example, powerful enough to keep the motor vehicle at a steady speed on a highway and/or to drive the vehicle without strong acceleration. The auxiliary motor is an electric booster motor, configured to provide extra power when necessary. For example, the auxiliary motor may be activated to help the vehicle cross a hill and/or to achieve greater acceleration, for example, when overtaking or when driving the vehicle in sport mode.

When the required drive torque is low enough to be delivered by the main motor, only the main motor is activated in order to achieve better energy efficiency. In such situations, the auxiliary motor is therefore not energized. However, its rotor, which is mechanically linked to the wheels of the vehicle, continues to rotate.

It is known to use a wound-rotor synchronous machine for the auxiliary motor. To be activated, the rotor of such an electric motor must be supplied with electrical current. For this purpose, the wound-rotor synchronous machine comprises an electric device for energizing the rotor that comprises a ring and a brush rubbing on the ring. The performance of such motors is advantageous. However, it has been observed that these motors rapidly get damaged if their rotor rotates when not energized. Thus, when the vehicle is used for a long period of time in way not requiring the auxiliary motor to be activated, the auxiliary motor may be damaged.

### PRESENTATION OF THE INVENTION

The aim of the invention is to provide a method for computing operational settings of a first motor and second motor of the same vehicle that overcomes the above drawbacks and that improves known prior-art methods.

More precisely, a first subject of the invention is a method for computing operational settings of a first motor and second motor of the same vehicle that makes it possible to prevent the second motor from being damaged.

### SUMMARY OF THE INVENTION

The invention relates to a method for computing operational settings of a first motor and second motor of the same vehicle, the second motor being an electric motor comprising a rotor and an electric device for energizing the rotor, the energizing device comprising at least one ring and at least one brush rubbing on the at least one ring, the computing method comprising:
a step of computing a thickness of a patina formed on the surface of said at least one ring, then
a step of comparing the patina thickness to a first threshold, then
if the patina thickness is greater than or equal to the first threshold, a step of computing the operational settings of the first motor and second motor according to a first strategy aiming to optimize the power consumption of the vehicle, and
if the patina thickness is strictly less than the first threshold, a step of computing the operational settings of the first motor and second motor according to a second strategy, distinct from the first strategy, and aiming to make an electrical current flow through said energizing device with a view to promoting regeneration of the patina.

Said step of computing the operational settings of the first motor and second motor according to the second strategy may comprise computing a torque setting of the second motor, the torque setting being equal to the minimum between:
a required drive torque of the vehicle,
a maximum torque that the second electric motor is capable of delivering, and
a maximum torque allowing a stable vehicle path to be maintained.

The patina thickness may be computed iteratively depending on a patina thickness computed in a previous iteration of the step of computing patina thickness, and depending on a variation in patina thickness itself computed depending on conditions of use of the second motor.

Said conditions of use of the second motor may comprise:
a datum relating to the speed of the second motor,
a datum relating to an excitation current of the rotor of the second motor, and
a datum relating to an ambient temperature.

The step of computing the patina thickness may comprise:
a substep of computing a temperature at an interface between the at least one ring and the at least one brush, and/or
a substep of computing a humidity at an interface between the at least one ring and the at least one brush.

The first motor may be configured to drive front wheels of the vehicle, and the second motor may be configured to drive rear wheels of the vehicle.

The computing method may comprise, consecutively to the step of computing the operational settings of the first motor and second motor according to the second strategy:
a step of computing a second patina thickness formed on the surface of said at least one ring consecutively to a period of operation of the second motor according to the second strategy,
a step of comparing the second patina thickness to a second threshold strictly greater than the first threshold, then
if the second patina thickness is strictly greater than the second threshold, a step of computing the operational settings of the first motor and second motor according to the first strategy.

Said step of computing the operational settings of the first motor and second motor according to the second strategy may comprise, if the patina thickness is strictly less than a third threshold, a step of computing an energization current of the rotor and an energization current of a stator of the second motor with a view to promoting regeneration of the patina at the expense of the efficiency of the second motor.

The third threshold may be equal to the first threshold, or the third threshold may be strictly less than the first threshold.

The invention also relates to a motor vehicle comprising a first motor and a second motor, the second motor being an electric motor comprising a rotor and an electric device for energizing the rotor, the energizing device comprising at least one ring and at least one brush rubbing on the at least one ring, the vehicle further comprising hardware and software means configured to implement the computing method such as defined above.

The invention also relates to a computer program product comprising program code instructions recorded on a computer-readable medium for implementing the steps of the computing method such as defined above when said program is run on a computer.

The invention also relates to a computer-readable data recording medium on which a computer program comprising program code instructions for implementing the computing method such as defined above is recorded.

The invention also relates to a signal of a data medium, carrying the computer program product such as defined above.

### PRESENTATION OF FIGURES

These objects, features and advantages of the present invention will be described in detail in the following description of one particular embodiment, which is given non-limitingly with reference to the appended figures, in which:

FIG. 1 is a schematic view of a motor vehicle according to one embodiment of the invention.

FIG. 2 is a block diagram of a method for computing operational settings of a first motor and second motor of the same vehicle according to one embodiment of the invention.

FIG. 3 is an overview of a method for computing operational settings of a first motor and second motor of the same vehicle according to one embodiment of the invention.

### DETAILED DESCRIPTION

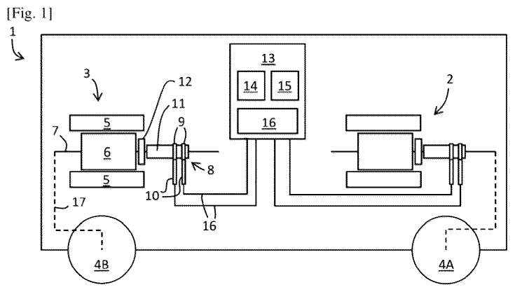

FIG. 1 schematically illustrates a profile view of a vehicle 1 according to one embodiment of the invention. In particular, the vehicle 1 is a motor vehicle, for example a passenger vehicle, a commercial vehicle, a truck or even a bus. The vehicle 1 comprises two motors 2, 3 that are capable of driving rotation of the wheels 4A, 4B of the vehicle, so as to make it advance. In the present case, a first motor 2 is coupled to front wheels 4A of the vehicle and a second motor 3 is coupled to rear wheels 4B of the vehicle. As a variant, this configuration could be reversed, i.e. the second motor 3 could be coupled to the front wheels and the first motor 2 could be coupled to the rear wheels. According to other variants, any other scheme of coupling of the first motor and second motor to all or some of the wheels of the vehicle could be envisioned. The first motor 2 may be qualified the main motor and the second motor 3 may be qualified the auxiliary motor. The second motor may be mainly intended to provide additional drive torque to the vehicle, for example to accelerate the vehicle quickly.

The second motor 3 is an electric motor comprising a stator 5 and a rotor 6 that is mounted so as to be able to rotate relative to the stator about a rotation axis 7. In particular, the second motor 3 is a wound-rotor synchronous machine. Therefore, the rotor 6 of the second motor 3 must be energized. For this purpose, the second motor comprises an electric energizing device 8 comprising at least one ring 9 and at least one brush 10, secured to a casing of the second motor 3, and rubbing on the at least one ring 9. In the present case, the energizing device 8 comprises two rings 9 and two brushes 10 rubbing on each of the rings, respectively. In particular, the two rings 9 may be mounted on a shaft 11 that is secured to the rotor 6, and borne by a bearing 12. The rings 9 comprise, on their surface, an oxidation layer that is generally denoted the “patina”, which facilitates current flow between the ring and the brush by decreasing a voltage drop. This patina may in particular be formed during a phase of breaking in the second motor.

The vehicle 1 further comprises an electronic control device 13 equipped with a memory 14, with a microprocessor 15 and with a power stage 16. The electronic control device 13 is configured to deliver an electrical current with a view to energizing the rotor 6 according to a setting computed by the microprocessor 15. In FIG. 1, electrical connections between the electronic control device 13 and the brushes 10 have been represented by solid lines 16. The mechanical link connecting the rear wheels 4B to the shaft 7 for its part has been represented by a dashed line 17.

In addition, the stator 5 may also be energized by the electronic control device 13. A given balance between the rotor energization current and the stator energization current allows the efficiency of the second motor 3 to be optimized.

The first motor 2 may also be an electric motor, and even also a wound-rotor synchronous machine. The first motor 2 may be analogous, or even identical to the second motor 3. As with the second motor, the stator and rotor of the first motor may be energized by the electronic control device 13. The rotor of the first motor 2 is mechanically connected to the front wheels 4A.

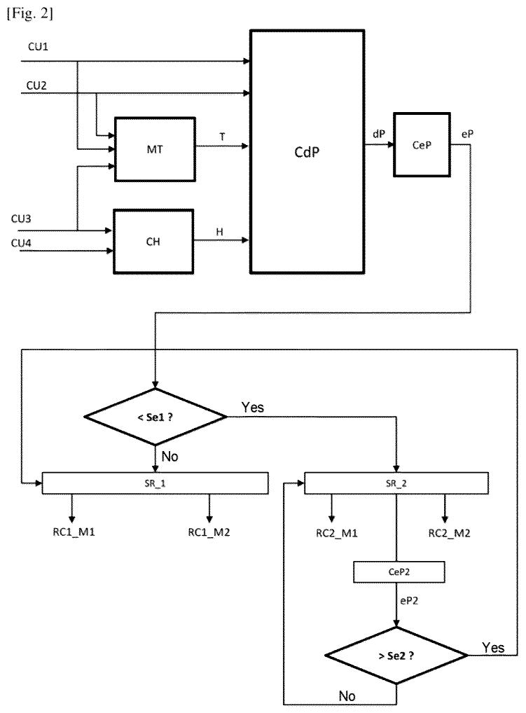

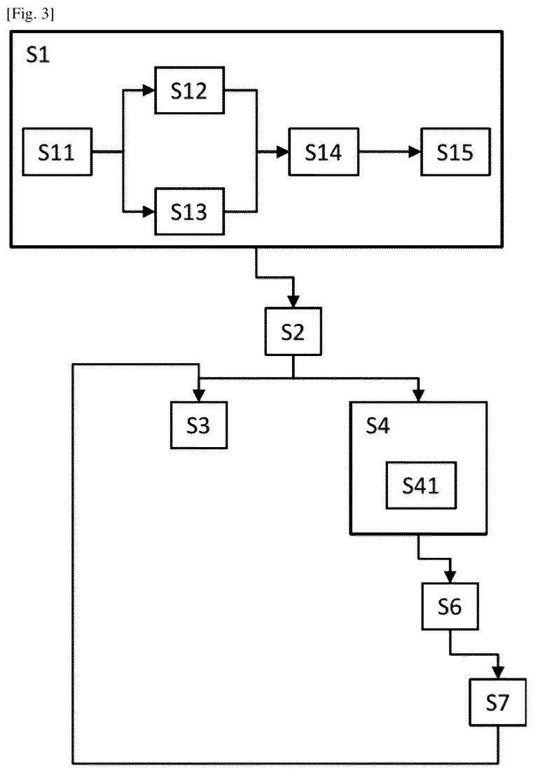

The memory 14 of the electronic control device 13 is a data recording medium on which is recorded a computer program comprising program code instructions for implementing a method for computing operational settings of the first motor 2 and second motor 3 according to one embodiment of the invention. The microprocessor 15 is capable of executing this computer program. One embodiment of this computing method will now be described with reference to FIGS. 2 and 3.

The computing method firstly comprises a first step S1 in which a patina thickness formed on the surface of the rings 9 is computed. The patina thickness may be computed iteratively depending on a patina thickness computed in a previous iteration of the first step S1 and depending on conditions of use of the second motor 3. An initial value of the patina thickness is then required to initiate the method. The conditions of use of the second motor therefore allow a variation in patina thickness to be computed.

In a first substep S11, said conditions of use are acquired. These conditions of use may be provided directly or indirectly, for example by sensors embedded in the vehicle. These conditions of use in particular include:
a datum CUI relating to the speed of the second motor, i.e. a datum characterizing the rate of rotation of the rotor relative to the stator;
a datum CU2 relating to an excitation current of the rotor 6 of the second motor 3, in particular the value of the amplitude of the electrical current flowing through the rotor 6; and
a datum CU3 relating to an ambient temperature, for example an atmospheric temperature in the environment of the vehicle.

These three data CU1, CU2, CU3 are delivered as input to a thermal model MT of the second motor 2. In a second substep S12, the thermal model MT computes a temperature T at an interface between the rings 9 and the brushes 10.

The datum CU3 relating to ambient temperature is delivered as input to a humidity computer CH. In a third substep S13, the humidity computer CH computes an absolute humidity H, or in other words a humidity level, at the interface between the rings 9 and the brushes 10. According to one embodiment Of the invention, this humidity level may be computed on the basis solely of the datum CU3 relating to ambient temperature. As a variant, this computation may be refined using data delivered by a humidity sensor and/or meteorological data CU4, which are for example obtained via a wireless communication network.

The temperature T and humidity H are then delivered as input to a computer CdP of variation in patina thickness. In a fourth substep S14, this computer CdP then computes a variation dP in patina thickness depending on the temperature T and humidity H. The variation dP in patina thickness may be positive if the operating conditions of the second motor 2 are favorable to regeneration of the patina, or negative if the operating conditions of the second motor 2 are unfavorable. In addition, predictive navigation data (provided by a navigation system) could also be used to make an estimation of the variation in patina thickness at the end of the period of use of the vehicle. The thermal model MT and/or the humidity computer and/or the computer CdP may comprise interpolated maps and/or functions in order to compute the temperature T, humidity H, and variation dP in patina thickness, respectively.

The variation dP in patina thickness is then delivered as input to a computer CeP of patina thickness. In a fifth substep S15, the computer Cep computes an effective patina thickness eP on the surface of the rings. This computation may be made by adding the previously computed variation dP in patina thickness to a previous value of patina thickness, computed in a previous iteration of step S1. At the end of the first step S1, an estimate of the patina thickness formed at the present time on the surface of the rings 9 is therefore obtained.

Next, in a second step S2, the previously computed patina thickness eP is compared to a first threshold Sel. The first threshold Sel is preferably a predefined value recorded in the memory 14 of the electronic control device 13. This first threshold may be set in a prior phase of calibrating the vehicle. Next, depending on the result of the comparison of the patina thickness eP to the first threshold Sel, two outcomes are possible.

According to a first outcome, if the patina thickness eP is greater than or equal to the first threshold Se1, or in other words if the patina thickness is judged large enough not to risk damage to the second motor 3, in a third step S3 operational settings of the first motor and second motor are computed according to a first strategy aiming to optimize the power consumption of the vehicle 1. This first strategy may be in accordance with the usual management strategy of vehicles equipped with two motors. In particular, this strategy leads to only the first motor 2 being activated if the torque request is less than or equal to the capabilities of the first motor, i.e. its maximum torque. In this case, the second motor is therefore not activated and in particular no electrical current flows through the energizing device 8. Nevertheless, the rotor 6 of the second motor is driven to rotate because of its mechanical link with the wheels 4B of the vehicle. The brushes 10 therefore rub on the rings 9 without electrical current flowing through this interface. Such a mode of operation tends to increase the temperature at the interface between the rings 9 and brushes 10 and therefore to degrade the patina, and in particular decrease its thickness. However, this is not disadvantageous because the patina thickness eP is sufficient to withstand such an operating mode, at least until the next iteration of the method. Of course, according to this first strategy, the second motor 3 may be activated if the torque request exceeds the capabilities of the first motor 2.

According to a second outcome, if the patina thickness eP is strictly less than the first threshold Se1, in a fourth step S4 operational settings of the first motor and second motor are computed according to a second strategy, distinct from the first strategy, aiming to make an electrical current flow through said energizing device with a view to promoting regeneration of the patina. Therefore, such an operating strategy does not aim to optimize the power consumption of the vehicle. On the contrary, this operating strategy has a lower energy efficiency than the first strategy but has the advantage of allowing regeneration of the patina, i.e. it to be restored to the surfaces of the rings 9. In particular, according to this second strategy, activation of the second motor 3 is forced even though the torque request is less than or equal to the capabilities of the first motor 2. The required torque may thus be delivered conjointly by the first motor 2 and second motor 3, or even exclusively by the second motor 3. Consequently, an electrical current flows through the energizing device 8, allowing regeneration of the patina.

The third step S3 and fourth step S4 govern the operation of the first motor 2 and second motor 3. In particular, steps S3 and S4 may comprise computing torque requests for each of the motors 2 and 3. In FIG. 2, these torque requests have been indicated, for the first strategy, by the references RC1_M1 and RC1_M2, for the first motor and second motor, respectively. For the second strategy, the torque requests have been indicated by the references RC2_M1 and RC2_M2, respectively. Alternatively, these steps may also comprise computing any quantity related to a torque request, such as computing an amplitude and/or voltage of an electrical control current of the motors 2 and 3.

For both the first strategy and second strategy, the control orders given to the motors 2 and 3 may be weighted by dynamic stability requirements of the vehicle. In particular, if the torque request is too high in relation to the conditions of adhesion of the vehicle to the road, it may in any case be limited to avoid loss of control of the vehicle.

The torque setting RC2_M2 of the second electric motor, if the patina thickness is strictly less than the first threshold Sel, may be equal to the minimum between:
a required drive torque of the vehicle, in particular a torque setting expressed by a driver of the vehicle by pressing on an accelerator pedal,
a maximum torque that the second electric motor is capable of delivering, and
a maximum torque allowing a stable vehicle path to be maintained.

Thus, if the required torque is less than or equal to the maximum torque that the second electric motor 3 is capable of delivering, then only the second motor is activated to produce the required torque, provided that conditions of adhesion of the vehicle to the ground are met so as to ensure a stable path. If the required torque is strictly greater than the maximum torque that the second electric motor 3 is capable of delivering, then the second motor is activated at its maximum power and the torque difference between the required torque and the maximum torque of the second motor is then delivered by the first motor.

Likewise, the torque setting RC1_M1 of the first electric motor, if the patina thickness is greater than or equal to the first threshold Sel, may be equal to the minimum between:
the required drive torque of the vehicle, in particular the torque setting expressed by a driver of the vehicle by pressing on the accelerator pedal,
a maximum torque that the first electric motor is capable of delivering, and
a maximum torque allowing a stable vehicle path to be maintained.
   If the required torque is strictly greater than the maximum torque that the first electric motor 2 is capable of delivering, then the first motor is activated at its maximum power and the torque difference between the required torque and the maximum torque of the first motor is then delivered by the second motor.

When the first motor and second motor control different axles, as is the case in the presented embodiment, the choice of one or other strategy causes the drive function of the vehicle to be moved from one axle to the other. This movement may be imperceptible or only slightly perceptible to users of the vehicle. Advantageously, to avoid changing strategy too frequently, the method may comprise a hysteresis cycle. More precisely, the method may comprise, consecutively to step S4, a fifth step S5 of computing a second patina thickness eP2 formed on the surface of said at least one ring consecutively to a period of operation of the second motor according to the second strategy. This computation may in particular be implemented by a computer CeP2 of patina thickness, that is identical or analogous to the computer CeP of patina thickness described above. In particular, the computation of the second patina thickness eP2 may be based on the torque setting RC2_M2 previously transmitted to the second motor. Next, in a sixth step S6, the second patina thickness eP2 is compared to a second threshold Se2 strictly greater than the first threshold Se1. If the patina thickness is strictly greater than the second threshold Se2, i.e. if the patina on the surface of the rings 9 is sufficiently regenerated, the operational settings of the first motor and second motor may be computed according to the first strategy, in accordance with the third step S3. Conversely, if the patina thickness is less than or equal to the second threshold Se2, i.e. if the surface patina of the rings 9 is insufficiently regenerated, the operational settings of the first motor and second motor may be computed according to the second strategy, in accordance with the third step S3.

According to another improvement of the invention, the fourth step S4 may comprise a substep E41 in which an energization current of the rotor and an energization current of a stator of the second motor are computed with a view to promoting regeneration of the patina at the expense of the efficiency of the second motor. In other words, it is a question of defining rotor and stator energization currents that do not target an optimum power consumption or an optimum efficiency of the second motor 3 but rather operation of the second motor allowing regeneration of the patina to be further accelerated. Specifically, operation of the second motor 3 is controlled via energization currents of the rotor and stator. These energization currents are generally set to reach a certain balance via a map specific to the second motor, in order to make the second motor operate with the best possible efficiency. This map comprises a set of parameters the values of which are set beforehand in a phase of tuning the motor. The improvement to the invention proposed here involves generating a second map of the second motor, distinct from the first map, the objective of which is not to target an optimum efficiency but rather better regeneration of the patina. This may for example be obtained by modifying a balance between the energization current of the rotor and the energization current of the stator. The advantage of this improvement is to allow even more effective regeneration of the patina; however, it requires the motor to be tuned a second time and sufficient computing and memory resources to implement it.

Substep S41 may be implemented when the previously computed patina thickness eP is strictly less than a third threshold. According to a first option, this third threshold may be equal to the first threshold Sel. Thus, substep S41 is systematically implemented as soon as the patina thickness is strictly less than the first threshold Sel. The computing method thus remains quite simple to implement. Alternatively, according to a second option, this third threshold may be strictly less than the first threshold Sel. Thus, substep S41 is implemented only if actuating the second motor with rotor and stator energization currents targeting an optimum power consumption is insufficient to regenerate the patina. Thus, this second option, which decreases the efficiency of the second motor, is implemented only as a last resort.

Finally, by virtue of the invention, it is ensured that the patina thickness of the second motor never becomes too small as this could lead to destruction of the second motor. The reliability of the second motor is therefore improved. Even though the vehicle sometimes operates in an operating mode different from the operating mode allowing optimum efficiency, the overall efficiency is improved because the lifespan of the vehicle is increased. In addition, the proposed computing method is simple to implement and requires limited computing resources. The invention may advantageously be applied to any transport vehicle comprising two motors at least one motor of which is a wound-rotor synchronous electric motor.

1. A method for computing operational settings of a first motor and second motor of the same vehicle, the second motor being an electric motor comprising a rotor and an electric device for energizing the rotor, the energizing device comprising at least one ring and at least one brush rubbing on the at least one ring, the computing method comprising:
a step of computing a thickness of a patina formed on a surface of said at least one ring; then
a step of comparing the patina thickness to a first threshold; then
if the patina thickness is greater than or equal to the first threshold, a step of computing the operational settings of the first motor and second motor according to a first strategy aiming to optimize power consumption of the vehicle; and
if the patina thickness is strictly less than the first threshold, a step of computing the operational settings of the first motor and second motor according to a second strategy, distinct from the first strategy, and aiming to make an electrical current flow through said energizing device with a view to promoting regeneration of the patina.

2. The computing method as claimed in claim 1, wherein said step of computing the operational settings of the first motor and second motor according to the second strategy comprises computing a torque setting of the second motor, the torque setting being equal to the minimum
a required drive torque of the vehicle,
a maximum torque that the second motor is capable of delivering, and
a maximum torque allowing a stable vehicle path to be maintained.

3. The computing method as claimed in claim 1, wherein the patina thickness is computed iteratively depending on a patina thickness computed in a previous iteration of the step of computing patina thickness, and depending on a variation in patina thickness itself computed depending on conditions of use of the second motor.

4. The computing method as claimed in claim 3, wherein said conditions of use of the second motor comprise:
a datum relating to speed of the second motor,
a datum relating to an excitation current of the rotor of the second motor, and
a datum relating to an ambient temperature.

5. The computing method as claimed in claim 1, wherein the step of computing the patina thickness comprises:
a substep of computing a temperature at an interface between the at least one ring and the at least one brush, and/or
a substep of computing a humidity at an interface between the at least one ring and the at least one brush.

6. The computing method as claimed in claim 1, wherein the first motor is configured to drive front wheels of the vehicle, and the second motor is configured to drive rear wheels of the vehicle.

7. The computing method as claimed in claim 1, further comprising, consecutively to the step of computing the operational settings of the first motor and second motor according to the second strategy:
a step of computing a second patina thickness formed on the surface of said at least one ring consecutively to a period of operation of the second motor according to the second strategy;
a step of comparing the second patina thickness to a second threshold strictly greater than the first threshold; then
if the second patina thickness is strictly greater than the second threshold, a step of computing the operational settings of the first motor and second motor according to the first strategy.

8. The computing method as claimed in claim 1, wherein said step of computing the operational settings of the first motor and second motor according to the second strategy comprises, if the patina thickness is strictly less than a third threshold, a step of computing an energization current of the rotor and an energization current of a stator of the second motor with a view to promoting regeneration of the patina at expense of efficiency of the second motor.

9. The computing method as claimed in claim 8, wherein the third threshold is equal to the first threshold or in that the third threshold is strictly less than the first threshold

10. A motor vehicle comprising a first motor and a second motor, the second motor being an electric motor comprising a rotor and an electric device for energizing the rotor, the energizing device comprising at least one ring and at least one brush rubbing on the at least one ring, the vehicle further comprising hardware and software means configured to implement the computing method as claimed in claim 1.
